(19) United States
(12) Patent Application Publication
(10) Pub. No.: US 2025/0364873 A1
(43) Pub. Date: Nov. 27, 2025

(54) EXTERNALLY EXCITED ELECTRIC MACHINE WITH ROTOR COOLING SYSTEM

(71) Applicant: Dana Automotive Systems Group, LLC, Maumee, OH (US)

(72) Inventors: Maarten DEBROUWERE, Zedelgem (BE); Frederik DESMET, Maldegem (BE); Jordi VAN DAMME, Brugge (BE); Joachim DRUANT, Houthulst (BE); Steven VANHEE, Hooglede (BE)

(21) Appl. No.: 18/673,089

(22) Filed: May 23, 2024

(51) Int. Cl. H02K 9/19; H02K 7/00; H02K 9/22

(52) U.S. Cl. CPC H02K 9/19; H02K 7/003; H02K 9/225

(57) ABSTRACT

Systems and methods for cooling an externally excited electric machine. An externally excited electric machine cooling system, in one example, includes rotor windings positioned radially outward from a rotor shaft and including a plurality of gaps between metal wire bundles. The externally excited electric machine cooling system further includes a cooling device positioned in the plurality of gaps and configured to directly cool the rotor windings.

### TECHNICAL FIELD

The present disclosure relates to an externally excited electric machine with a rotor cooling system that routes coolant through gaps between rotor windings.

### BACKGROUND AND SUMMARY

Electric motors are used in vehicles to generate motive power and in a variety of other fields. Rare earth magnets are used in some electric motors due to the efficiency that can be achieved by permanent magnet motors. To further increase motor efficiency, cooling systems have been used in certain motors.

U.S. Pat. No. 8,022,582 B2 to Dames et al. discloses a liquid cooled permanent magnet rotor. The rotor cooling system routes oil through a rotor shaft and then to radial passages which are near the end of the rotor shaft in an attempt to cool the rotor.

The inventors have recognized several drawbacks with Dames' liquid cooled permanent magnet motor and other prior permanent magnet motors. For instance, the use of permanent magnets in Dames' motor as well as other motors may have environmental and economic drawbacks. Further, externally excited electric motors have different temperature gradients in comparison to permanent magnet motors where heat is generated in the permanent magnets. Consequently, the cooling challenges in externally excited electric motors varies from permanent magnet motors. For instance, losses in the rotor windings in the externally excited motor may be higher when compared to electrical losses in other types of motors such as permanent magnet motors. Further, externally excited electric motors may have smaller shaft diameters than other motors which further complicates motor cooling challenges due to the decrease in rotor shaft size which causes a decrease in rotor shaft cooling passage efficiency.

Recognizing the abovementioned drawbacks of previous motors, the inventors developed an externally excited electric machine cooling system to at least partially overcome the drawbacks. The externally excited electric machine cooling system includes, in one example, rotor windings positioned radially outward from a rotor shaft and including multiple gaps between metal wire bundles. The externally excited electric machine cooling system additionally includes a cooling device positioned in the gaps and configured to directly cool the rotor windings. In this way, the rotor is effectively cooled to increase the machine's operating efficiency through the use of what was formerly unused space in the metal wire bundles of the rotor windings. To elaborate, the electric machine is able to achieve target efficiencies for a variety of applications and vehicle platforms, specifically, using materials which are easier to source than rare earth magnets.

In one example, the cooling device may include multiple cooling tubes. In such an example, the cooling tubes may be in fluidic communication with a rotor shaft cooling passage. Further, in such an example, the cooling tubes may be in fluidic communication with rotor end winding enclosures. In this way, the machine's operating efficiency is further increased by cooling the rotor end windings.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE FIGURES

FIG. 1 is a diagram of an exemplary system with an externally excited electric machine with a cooling system.

FIG. 2 shows a cross-sectional view of an example of a cooling system with cooling tubes.

FIG. 3 shows a cross-sectional view of an example of a cooling system with coolant directed directly through gaps in the wire bundles in the rotor windings.

FIG. 4 shows a cross-sectional view of an example of a cooling system with heat pipes.

FIGS. 5-6 show other cross-sectional views of different examples of a cooling system with cooling tubes.

FIG. 7 shows another cross-sectional view of an example of a cooling system with coolant directed directly through gaps in the wire bundles in the rotor windings.

FIGS. 8-9 show cross-sectional view of another example of a cooling system in a rotor.

FIG. 10 shows another cross-sectional view of the cooling system, depicted in FIG. 3.

### DETAILED DESCRIPTION

An externally excited electric machine with a rotor cooling arrangement that achieves increased efficiency is described herein. The rotor cooling arrangement includes a cooling device arranged within gaps in rotor windings for directly cooling the rotor windings. The cooling device may take a variety of forms, in different embodiments. For instance, the cooling device may take the form of multiple cooling tubes where coolant is pumped therethrough. The cooling device may also take the form of multiple heat pipes. In the heat pipe example, the heat pipes may be cooled by coolant which is sprayed or circulated around the rotor end windings in an immersive manner. In other embodiments, coolant may flow directly through the rotor winding gaps which is plugged at one end.

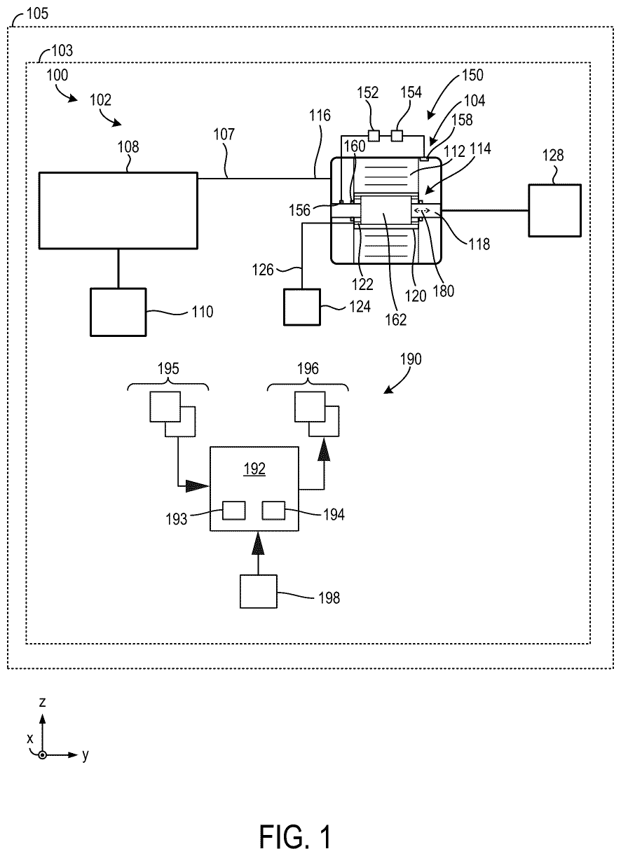

FIG. 1 shows an example of an electric drive 100 with an externally excited electric machine system 102. The electric drive 100 may be included in an electric powertrain 103 of a vehicle 105, in one example. In such an example, the electric machine included in the electric drive may be a traction motor. However, it will be understood that the electric drive 100 may be used in a variety of fields including, but not limited to, industrial machines, agricultural systems, mining systems, and the like.

The externally excited electric machine system 102 includes an externally excited electric machine 104 (e.g., an externally excited synchronous motor (EESM)) that is electrically coupled to an inverter 108 via electrical connections 107 (e.g., wires, bus bars, combinations thereof, and the like).

In the electric drive 100, the inverter 108 is electrically coupled to the externally excited electric machine 104. The inverter 108 may be electrically connected to an energy storage device 110 (e.g., one or more traction batteries, capacitor(s), fuel cell(s), combinations thereof, and the like). As such, electrical energy may flow between the inverter and the energy storage device during drive operation and regeneration operation, when the externally excited electric machine 104 is designed as a motor-generator.

The externally excited electric machine 104 includes a stator 112 and a rotor 114. The rotor 114 includes a rotor shaft 118 and a rotor core 120 which include externally excited rotor windings 122 which may include copper or aluminum coils. The rotor windings 122 are electrically coupled to an energy source 124 via electrical connections 126. The energy source 124 may include an inverter or DC/DC converter for exciting the rotor windings which may be electrically coupled to the energy storage device 110 and/or another suitable energy storage device. Further, due to the use of externally excited rotor windings in the electric machine, permanent magnets may not be included the rotor.

The electric drive 100 may be coupled to downstream components 128. In the EV example, the downstream components 128 may include one or more drive axle assemblies, drive wheels, a transmission (e.g., a gearbox), and the like.

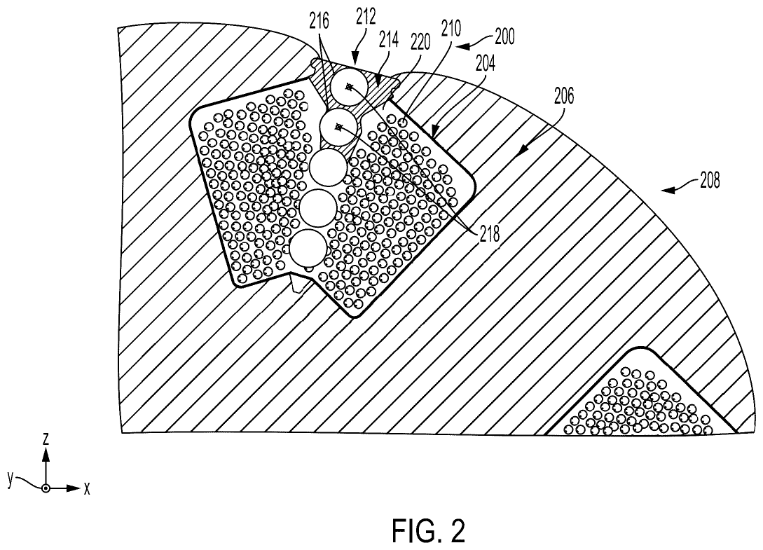

The electric machine 102 further includes a cooling system 150 that is configured to remove heat from the rotor 114. The cooling system 150 is schematically depicted in FIG. 1. However, it will be understood that the cooling system has greater complexity that is elaborated upon herein with regard to the example cooling systems depicted in FIGS. 2-10.

The cooling system 150, in the illustrated example, includes a heat exchanger 152 and a pump 154. The heat exchanger 152 and the pump 154 are depicted external to the electric machine 102, in the illustrated example. However, the heat exchanger and/or the pump may be incorporated into the electric machine, in other examples.

In one example, the outlet of the heat exchanger 152 may be in fluidic communication with an inlet 156 of a rotor shaft cooling passage and the inlet of the pump may be in fluidic communication with a sump 158 or in direct fluidic communication with rotor winding enclosures which immersively cool the windings. In another example, the outlet of the pump may be in fluidic communication with a rotor shaft cooling passages and the inlet of the heat exchanger may be in fluidic communication with a sump or in direct fluidic communication with rotor winding enclosures which immersively cool the windings. In other examples, the pump and the heat exchanger may be in fluidic communication with a portion of the rotor cooling system that either cools the rotor end windings via coolant spray or immersive cooling. In such an example, the rotor cooling system may include heat pipes that are incorporated into the rotor and the heat pipes may be sprayed by the coolant that is also directed at the rotor end windings or extend into the immersive cooling enclosures around the end windings. Various architectures of exemplary rotor cooling systems are shown in FIGS. 2-10 and discussed in greater detail herein.

The cooling system 150 includes a cooling device 162 which is schematically depicted in FIG. 1. However, it will be understood that the cooling device has greater complexity, in practice, that is expanded upon herein. The cooling device 162 may include cooling tubes, heat pipes, and/or coolant conduits arranged in gaps between winding wires. To elaborate, the rotor 114 includes metal wire bundles for each pole with gaps between the wires. The gaps, which are discussed in greater detail herein, may be formed in the rotor for manufacturing reasons. To elaborate, a method for winding the copper coils of the rotor may involve a needle winding method where the round copper wire is guided by a comparatively small needle around the iron poles. For mechanical strength reasons these needles may have a minimum diameter which is larger than the diameter of the copper wire. Additionally, the needle may be kept at a sufficient distance from the neighboring coil to avoid unwanted contact which could cause degradation to the insulation. Other methods may be used to wind the coils which also demand a minimum gap between the coils for similar reasons. The wire bundles may be constructed out of a suitable metal such as copper, aluminum, combinations thereof, and the like.

The coolant in the cooling system 150 depicted in FIG. 1 as well as the other cooling systems described herein may be oil. Bearings 160 are coupled to the rotor shaft 118 in the illustrated example. In one example, the rotor shaft cooling passage may direct oil through the bearings to provide lubrication thereto and decrease bearing wear.

The electric drive 100 may further include a control system 190 with a controller 192 as shown in FIG. 1. The controller 192 may include a microcomputer with components such as a processor 193 (e.g., a microprocessor unit), input/output ports, an electronic storage medium 194 for executable programs and calibration values (e.g., a read-only memory chip, random access memory, keep alive memory, a data bus, and the like). The storage medium may be programmed with computer readable data that represents instructions that are executable by a processor for performing the methods and control techniques described herein as well as other variants that are anticipated but not specifically listed. As such, control techniques, methods, and the like expanded upon herein may be stored as instructions in non-transitory memory.

The controller 192 may receive various signals from sensors 195 coupled to various regions of the electric drive 100. For example, the sensors 195 may include a rotor current sensor, an electric machine speed sensor, a stator current sensor, an electric machine temperature sensor, an auxiliary contact sensor, a battery state of charge sensor, an inverter current sensor, and the like. Electric machine speed may be ascertained from the amount of power sent from the inverter 108 to the electric machine 104. An input device 198 (e.g., an accelerator pedal, a brake pedal, a drive mode selector, a gear selector, combinations thereof, and the like, in the EV example) may further provide input signals indicative of an operator's intent for electric drive control.

Although, one controller is depicted in FIG. 1, it will be understood that the electric drive and the system in which it is incorporated, such as a vehicle, may include multiple controllers. For instance, in the EV example, a vehicle control unit (VCU) may be included in the control system 190. Additionally, a motor control unit (MCU) may be included in the control system. In such an example, the VCU and the MCU may be distinct controllers with independent hardware and may be formed in separate enclosures which are spaced away from one another. However, in other examples, the VCU and the MCU may be collocated. In either case, the VCU and the MCU are in electronic communication with one another.

Upon receiving the signals from the various sensors 195 of FIG. 1, the controller 192 processes the received signals, and employs various actuators 196 of the electric drive components to adjust the components based on the received signals and instructions stored on the memory of controller 192. For example, the controller 192 may receive a signal indicative of an operator's request for increased electric machine output. In response, the controller 192 may command operation of the inverter 108 to adjust the electric machine's mechanical power output and increase the power delivered from the externally excited electric machine 104 to the downstream components 128. The other controllable components in the electric drive may function in a similar manner in relation to sensor inputs and command outputs.

An axis system is provided in FIG. 1 as well as FIGS. 2-10 for reference. The z-axis may be a vertical axis (e.g., parallel to a gravitational axis), the x-axis may be a lateral axis (e.g., horizontal axis), and the y-axis may be a longitudinal axis, in one example. However, in other examples, the axes may have other orientations. Further, a rotational axis 180 of the electric machine 104 is provided in FIG. 1 for reference.

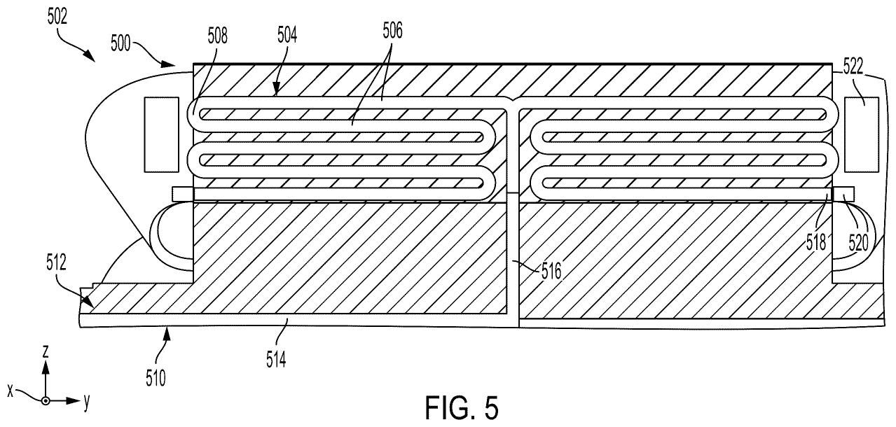

FIGS. 2-10 show examples of cooling devices for cooling systems which may be used in the externally excited electric machine 104 show in FIG. 1 or other suitable externally excited electric machines. To elaborate, FIGS. 2-4 and 9 show cross-sectional view of exemplary rotor cooling devices where the cutting plane is normal to the electric machine's rotational axis and FIGS. 5-8 and 10 show cross-sectional view of exemplary rotor cooling devices where the cutting plane is a radial plane that extends through the electric machine's rotational axis.

FIG. 2 specifically shows an example of a cooling system 200 in a rotor 208 of an externally excited electric machine. The externally excited electric machine and the other electric machines described herein may specifically be synchronous externally excited electric machines where shaft rotation is synchronized with the frequency of the supply current.

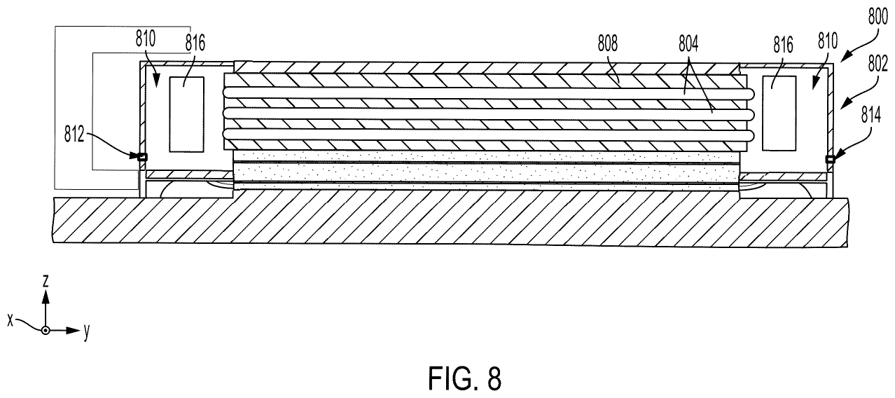

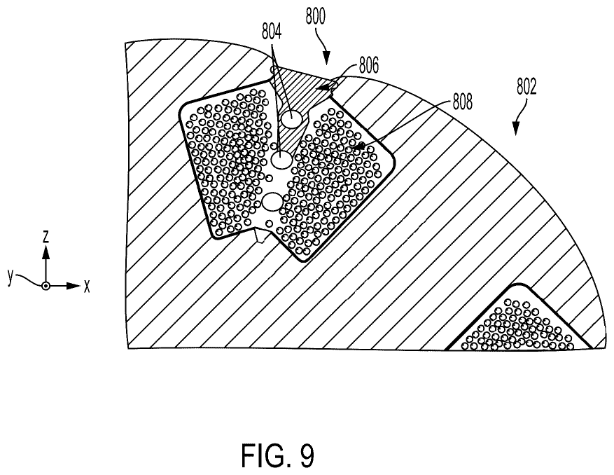

Rotor windings 204 extend through a rotor body 206 in the rotor 208. The rotor windings 204 are formed from metal wires 210 (e.g., copper wires, aluminum wires, combinations thereof, and the like). A cooling tube 212 is included in the cooling system 200. The cooling tube 212 is positioned in a gap 214 between the wires 210. To elaborate, in the illustrated example, the cooling tube 212 includes sections 216 that are formed as passes for circuitously routing the tube through the rotor 208. It will be understood, that the other windings in the rotor with a gap therein may include a similar cooling tube. In such an example, the cooling tubes in the gaps may be fluidly connected in parallel which has the advantage that the influence of the heating of the cooling fluid on the rotor cooling performance is constrained. In other examples, each gap in the different rotor windings sections may include multiple cooling tubes through which coolant is directed in parallel. FIGS. 8-9 show another example of a cooling system 800 in a rotor 802 that include multiple cooling tubes 804 through which coolant is routed in parallel through a gap 806 in the rotor windings 808. The rotor cooling system 800 further includes coolant collectors 810 on both axial sides. The coolant collectors 810 may include a coolant outlet 812 and a coolant inlet 814 or vice versa which allows coolant to be routed to a pump and/or other suitable cooling system components. End windings 816 may be positioned within the coolant collectors 810.

The central axes 218 of the sections 216 may be parallel to the rotational axis of the electric machine. Additionally, each axial side of the electric machine may include a cooling tube with a similar layout, in one example. In such an example, the cooling tubes may receive coolant from a passage which traverses the rotor shaft. The rotor shaft cooling passage is discussed in greater detail herein with regard to FIGS. 5-7.

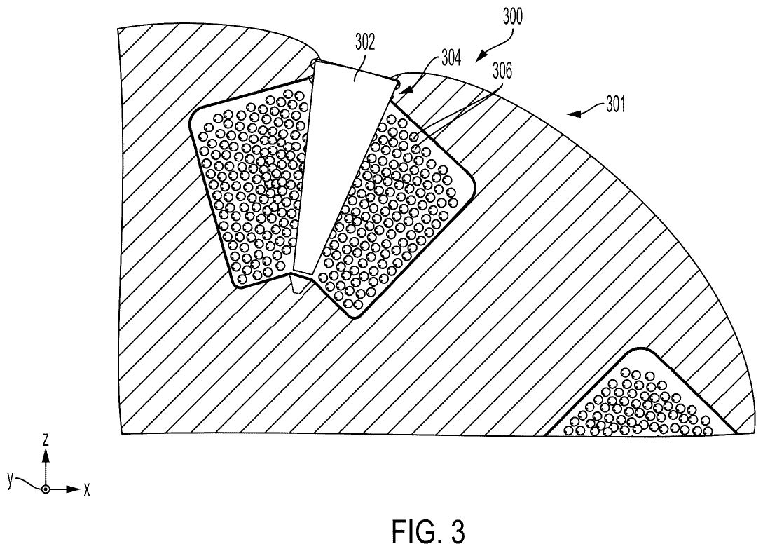

Continuing with the cooling tube example of the cooling device depicted in FIG. 3, outlets of the cooling tubes may either direct coolant into enclosure around the rotor end windings for immersion cooling or provide coolant to nozzles which spray coolant at the end windings. The rotor shaft coolant passage may receive coolant from a pump and a heat exchanger.

In the illustrated example, a thermoset material 220 is located around the cooling tube 212 and between the winding wires 210. The thermoset material 220 include an epoxy and/or a thermoplastic. A thermoset material may be provided around a least a portion of the other cooling devices described herein which are positioned in the gap between the rotor winding wires. Using a thermoset material in the cooling system allows the structural rigidity of the cooling assembly to be increased, thereby increasing the cooling system's durability.

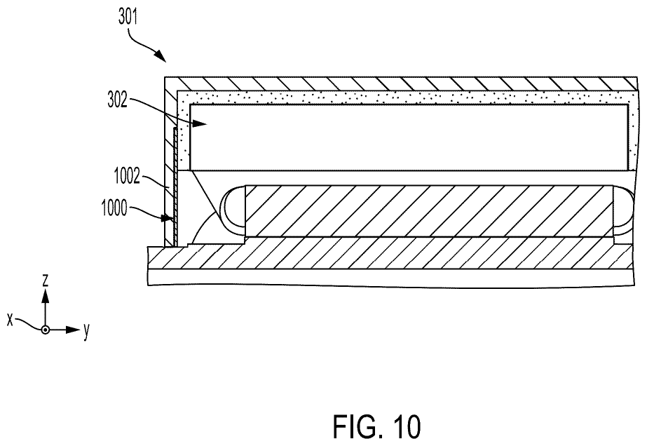

FIG. 3 shows another example of a cooling system 300 in a rotor 301 of an externally excited electric machine. with a coolant passage 302 which is formed in a gap 304 between end winding wires 306. An end of the gap may be blocked to contain the coolant in the gaps. To elaborate, as shown in FIG. 10, a groove 1000 may be included in an end plate 1002 for routing coolant back to the coolant passage 302 in the rotor 301. To elaborate, the groove 1000 is formed as a radial inward channel that is incorporated into the end plate 1002 to guide fluid back to the rotor shaft.

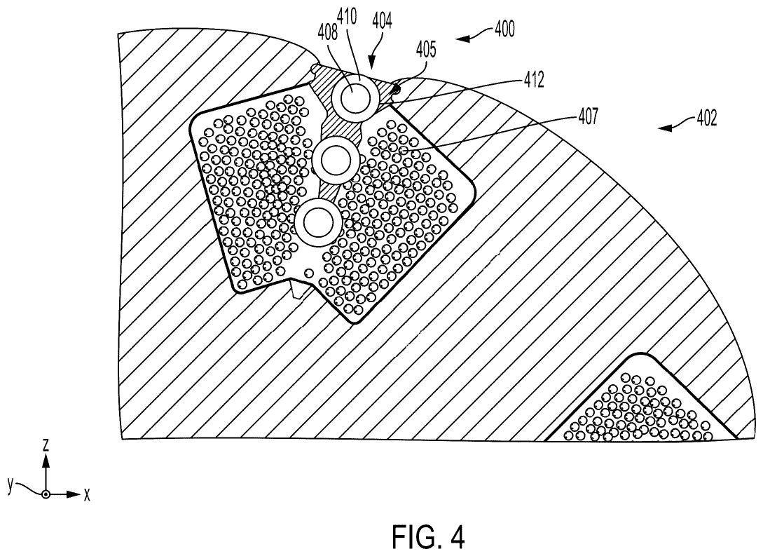

FIG. 4 shows another example of a cooling system 400 in a rotor 402 of an externally exited electric machine. The cooling system 400 includes heat pipes 404 positioned in a gap 405 between wires 407. The heat pipes 404 each includes a vapor cavity 408 which is surrounded by a wicking section 410. Both the vapor cavity 408 and the wicking section 410 are enclosed by a housing 412 to form a sealed enclosure.

FIG. 5 shows a cross-sectional view of a cooling system 500 in a rotor 502 of an externally excited electric machine where the cooling system includes cooling tubes 504. The cooling tubes 504, in the illustrated example, are circuitously routed through the gap such that they make multiple longitudinal passes. Thus, the cooling tubes 504 each includes multiple sections 506 that are parallel to one another and curved sections 508 which fluidly connect the parallel sections of the tubes. However, other cooling tube contours are possible.

Further, a rotor shaft cooling passage 510 provides coolant to the cooling tubes 504. To elaborate, the rotor shaft cooling passage 510 extends axially through the rotor shaft 512 via an axial section 514 and additionally includes a radially extending section 516 that is centrally located along the shaft rotor shaft, in the illustrated example. The rotor shaft cooling passage 510 receives coolant from a pump and may route coolant through one or more bearings which are coupled to the rotor shaft 512.

Outlets 518 of the cooling tubes 504 are in fluidic communication (e.g., directly fluidic communication) with nozzles 520. The nozzles 520 spay coolant towards the rotor end windings 522 for increased rotor cooling.

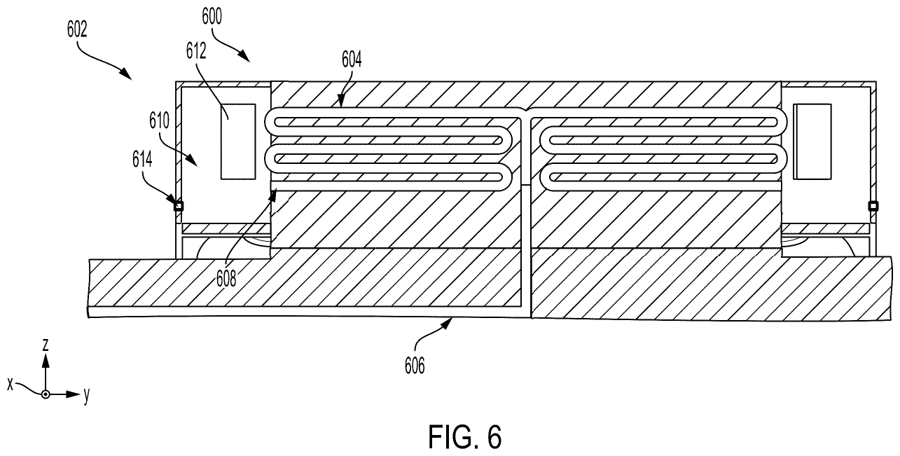

FIG. 6 shows a cross-sectional view of a cooling system 600 in a rotor 602 of an externally excited electric machine where the cooling system 600 includes cooling tubes 604 in fluidic communication with a rotor shaft cooling passage 606, similar to the cooling system 500, shown in FIG. 5. Redundant description of the overlapping features of the cooling systems is omitted for brevity. However, outlets 608 of the cooling tubes 604 are in fluidic communication with rotor end winding enclosures 610 that enclose rotor end windings 612 and therefore immersively cool the end windings. The enclosures 610 include outlets 614 which are in fluidic communication with a coolant sump, in the illustrated example.

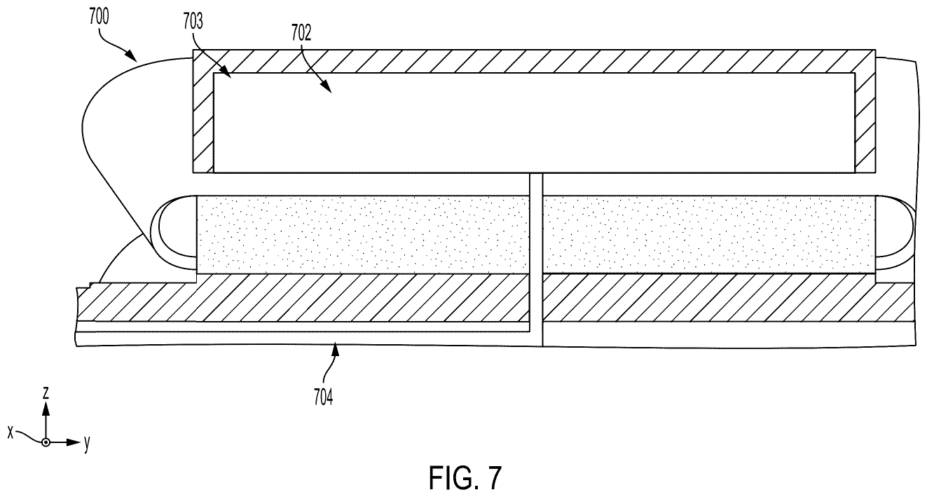

FIG. 7 shows another example of a cooling system 700 with a coolant passage 702 which is formed in a gap 703 between end winding wires. The coolant passage 702 is in fluidic communication with a rotor shaft cooling passage 704, in the illustrated example. An end of the gap may be blocked to contain the coolant in the gaps.

FIGS. 1-7 provide for a method for operation of an externally excited electric machine cooling system. The method may be implemented by any of the electric machine cooling systems described herein or combinations of the cooling systems. In other examples, the method may be implemented by other suitable cooling systems. Furthermore, the method may be implemented by a controller that includes memory which holds instructions for implementing the method steps that are executable by a processor, as previously indicated. The method includes flowing coolant into a rotor shaft cooling passage from a pump. Next the method includes flowing coolant from the rotor shaft cooling passage to a cooling device from the rotor shaft cooling passages. To elaborate, the method includes flowing a coolant into a cooling device positioned in the plurality of gaps. The method further includes flowing coolant from the cooling device into immersive rotor end winding enclosures, in one example. In another example, the method may further include spraying coolant onto rotor end windings via nozzles that are in direct fluidic communication with the cooling device.

The technical effect of the externally excited electric machine cooling system operating methods described herein is to effectively cool rotor windings by routing coolant through gaps between winding wires, thereby increasing electric machine operating efficiency.

FIGS. 1-10 shows example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Additionally, elements co-axial with one another may be referred to as such, in one example. Further, elements shown intersecting one another may be referred to as intersecting elements or intersecting one another, in at least one example. Further still, an element shown within another element or shown outside of another element may be referred as such, in one example. In other examples, elements offset from one another may be referred to as such.

The invention will be further described in the following paragraphs. In one aspect, an externally excited electric machine cooling system is provided that comprises rotor windings positioned radially outward from a rotor shaft and including a plurality of gaps between metal wire bundles; and a cooling device positioned in the plurality of gaps and configured to directly cool the rotor windings. In one example, the cooling device may include a plurality of cooling tubes. In another example, the plurality of cooling tubes may be embedded in a thermoset material. In another example, the thermoset material may include one or more of epoxy and thermoplastic. In yet another example, the plurality of cooling tubes may be in fluidic communication with a rotor shaft cooling passage. In another example, the rotor shaft cooling passage may be in fluidic communication with a rotor shaft bearing. In another example, the plurality of cooling tubes may be in fluidic communication with rotor end winding enclosures. In yet another example, the cooling device may include a plurality of heat pipes. In another example, the plurality of heat pipes may be cooled via a rotor end winding spray nozzle or via immersive rotor end winding enclosures. In another example, a working fluid in the externally excited electric machine cooling system may be oil.

In another aspect, a method for operation of an externally excited electric machine cooling system is provided that comprises flowing a coolant into a cooling device positioned in the plurality of gaps; wherein the externally excited electric machine cooling system includes: rotor windings positioned radially outward from a rotor shaft and including a plurality of gaps between metal wire bundles; and a cooling device positioned in the plurality of gaps and configured to directly cool the rotor windings. In one example, the method may further include flowing coolant from the cooling device into immersive rotor end winding enclosures. In one example, the method may further include spraying coolant onto rotor end windings via nozzles that are in direct fluidic communication with the cooling device. In one example, flowing the coolant into the cooling device may include flowing the coolant from a rotor shaft cooling passage into the cooling device. In one example, the cooling system may include a plurality of cooling tubes that are embedded in an epoxy or a thermoplastic.

In another aspect, an externally excited synchronous electric machine cooling system, comprising: rotor windings positioned radially outward from a rotor shaft and including a plurality of gaps between metal wire bundles; and a plurality of cooling tubes positioned in the plurality of gaps and configured to directly cool the rotor windings; and a rotor shaft cooling passage in direct fluidic communication with the plurality of cooling tubes. In another example, outlets of the plurality of cooling tubes may be configured to: deliver coolant to multiple nozzles which spray coolant towards the rotor windings; or deliver coolant to immersive rotor end winding enclosures. In yet another example, the plurality of cooling tubes may be in fluidic communication with a rotor shaft cooling passage. In another example, the plurality of cooling tubes may be embedded in an epoxy or a thermoplastic. In another example, the externally excited synchronous electric machine may be a traction motor included in an electric drive.

While various embodiments have been described above, it should be understood that they have been presented by way of example, and not limitation. It will be apparent to persons skilled in the relevant arts that the disclosed subject matter may be embodied in other specific forms without departing from the spirit of the subject matter. The embodiments described above are therefore to be considered in all respects as illustrative, not restrictive. As such, the configurations and routines disclosed herein are exemplary in nature, and that these specific examples are not to be considered in a limiting sense, because numerous variations are possible. For example, the above technology can be applied to a variety of systems that include electric drives with different types of propulsion sources including internal combustion engines, in a hybrid vehicle example. The subject matter of the present disclosure includes all novel and non-obvious combinations and sub-combinations of the various systems and configurations, and other features, functions, and/or properties disclosed herein.

Note that the example control and estimation routines included herein can be used with various electric drive and/or system configurations. The control methods and routines disclosed herein may be stored as executable instructions in non-transitory memory and may be carried out by the control system including the controller in combination with the various sensors, actuators, and other electric drive and/or system hardware in combination with the electronic controller. As such, the described actions, operations, and/or functions may graphically represent code to be programmed into non-transitory memory of the computer readable storage medium in the electric drive and/or the system. The various actions, operations, and/or functions illustrated may be performed in the sequence illustrated, in parallel, or in some cases omitted. Likewise, the order of processing is not necessarily required to achieve the features and advantages of the examples described herein, but is provided for ease of illustration and description. One or more of the illustrated actions, operations and/or functions may be repeatedly performed depending on the particular strategy being used. One or more of the method steps described herein may be omitted if desired.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. An externally excited electric machine cooling system, comprising:
rotor windings positioned radially outward from a rotor shaft and including a plurality of gaps between metal wire bundles; and
a cooling device positioned in the plurality of gaps and configured to directly cool the rotor windings.

2. The externally excited electric machine cooling system of claim 1, wherein the cooling device includes a plurality of cooling tubes.

3. The externally excited electric machine cooling system of claim 2, wherein the plurality of cooling tubes are embedded in a thermoplastic material.

4. The externally excited electric machine cooling system of claim 2, wherein the plurality of cooling tubes are embedded in an epoxy.

5. The externally excited electric machine cooling system of claim 2, wherein the plurality of cooling tubes are in fluidic communication with a rotor shaft cooling passage.

6. The externally excited electric machine cooling system of claim 5, wherein the rotor shaft cooling passage is in fluidic communication with a rotor shaft bearing.

7. The externally excited electric machine cooling system of claim 2, wherein the plurality of cooling tubes are in fluidic communication with rotor end winding enclosures.

8. The externally excited electric machine cooling system of claim 1, wherein the cooling device includes a plurality of heat pipes.

9. The externally excited electric machine cooling system of claim 8, wherein the plurality of heat pipes are cooled via a rotor end winding spray nozzle or via immersive rotor end winding enclosures.

10. The externally excited electric machine cooling system of claim 1, wherein a working fluid in the externally excited electric machine cooling system is oil.

11. A method for operation of an externally excited electric machine cooling system, comprising:
flowing a coolant into a cooling device positioned in a plurality of gaps;
wherein the externally excited electric machine cooling system includes:
rotor windings positioned radially outward from a rotor shaft and including the plurality of gaps between metal wire bundles; and
the cooling device positioned in the plurality of gaps and configured to directly cool the rotor windings.

12. The method of claim 11, further comprising flowing coolant from the cooling device into immersive rotor end winding enclosures.

13. The method of claim 11, further comprising spraying coolant onto rotor end windings via nozzles that are in direct fluidic communication with the cooling device.

14. The method of claim 11, wherein flowing the coolant into the cooling device includes flowing the coolant from a rotor shaft cooling passage into the cooling device.

15. The method of claim 11, wherein the externally excited electric machine cooling system includes a plurality of cooling tubes that are embedded in an epoxy or a thermoplastic material.

16. An externally excited synchronous electric machine cooling system, comprising:
rotor windings positioned radially outward from a rotor shaft and including a plurality of gaps between metal wire bundles;
a plurality of cooling tubes positioned in the plurality of gaps and configured to directly cool the rotor windings; and
a rotor shaft cooling passage in direct fluidic communication with the plurality of cooling tubes.

17. The externally excited synchronous electric machine cooling system of claim 16, wherein outlets of the plurality of cooling tubes are configured to:
deliver coolant to multiple nozzles which spray coolant towards the rotor windings; or
deliver coolant to immersive rotor end winding enclosures.

18. The externally excited synchronous electric machine cooling system of claim 17, wherein a working fluid in the cooling system is oil.

19. The externally excited synchronous electric machine cooling system of claim 18, wherein the plurality of cooling tubes are embedded in an epoxy or a thermoplastic.

20. The externally excited synchronous electric machine cooling system of claim 16, wherein the externally excited synchronous electric machine is a traction motor included in an electric drive.
